(19) United States
(12) Patent Application Publication
(10) Pub. No.: US 2013/0105685 A1
(43) Pub. Date: May 2, 2013

(54) Method and Apparatus for Reduced Membrane Desorption Time in Ion Molecular Spectrometry

(71) Applicants: Hector Robert, San Diego, CA (US); Hacene Boudries, Andover, MA (US); Erik Edmund Magnuson, Cardiff by the Sea, CA (US); Christopher Crowley, San Diego, CA (US)

(72) Inventors: Hector Robert, San Diego, CA (US); Hacene Boudries, Andover, MA (US); Erik Edmund Magnuson, Cardiff by the Sea, CA (US); Christopher Crowley, San Diego, CA (US)

(21) Appl. No.: 13/287,405

(22) Filed: Nov. 2, 2011

(51) Int. Cl. H01J 49/04; B23K 26/00; F24J 3/00

(52) U.S. Cl. 250/288; 432/9; 219/121.6

(57) ABSTRACT

An ion mobility spectrometer including an ion identifying unit, a detector in flow communication with the identifying unit, a gas inlet configured to provide gas carrying a sample of interest, a membrane substantially covering the first opening of the detector inlet, the membrane configured to capture the sample of interest on an exterior surface of the membrane, a heating device coupled to the membrane, the heating device configured to increase a temperature of the membrane to a temperature threshold level once the sample of interest is captured enabling molecules in the captured sample of interest to pass through the membrane and into the detector inlet, and a radiant heat source configured to apply radiant heat to the membrane to increase the temperature of the membrane to the temperature threshold level.

### BACKGROUND OF THE INVENTION

The embodiments described herein relate generally to ion molecular spectrometry and, more particularly, to reducing membrane desorption time in an ion mobility spectrometry detector.

Ion mobility spectrometry (IMS) is a sensitive analytical technique that is used for detection, identification, and monitoring of chemicals, explosives, highly toxic gases, and drug interdiction. Conventional ion mobility detectors may use a membrane inlet system for capturing molecules from the. Heat is thereafter applied to the membrane to increase a permeability of the membrane in order to allow the captured molecules to diffuse through the membrane and continue on to a detection device where the molecules are ultimately identified. However, capturing molecules, heating a membrane to a proper temperature, and identifying the molecules that have diffused through the membrane is a very time consuming process that may take several seconds.

### BRIEF SUMMARY OF THE INVENTION

In one aspect, an ion mobility spectrometer is provided. Ion mobility spectrometer includes an ion identifying unit, a detector inlet having a first end defining a first opening and an opposing second end defining a second opening, the second end coupled in flow communication with the identifying unit, a gas inlet configured to provide gas carrying a sample of interest, a membrane substantially covering the first opening of the detector inlet, the membrane in communication with the gas carrying the sample of interest, the membrane configured to capture the sample of interest on an exterior surface of the membrane, a heating device coupled to the membrane, the heating device configured to increase a temperature of the membrane to a temperature threshold level by heat diffusion once the sample of interest is captured, wherein at the temperature threshold level, a permeability of the membrane enables molecules in the captured sample of interest to pass through the membrane and into the detector inlet, and a radiant heat source configured to apply radiant heat to the membrane to increase the temperature of the membrane to the temperature threshold level.

In another aspect, a method is provided. The method includes impinging a gas carrying a sample of interest on an exterior surface of a membrane, enabling a heating device coupled to the membrane to increase a temperature of the membrane to a temperature threshold level, wherein at the temperature threshold level, a permeability of the membrane enables molecules in the sample of interest captured on the exterior surface of the membrane to pass through the membrane, and enabling a radiant heat source to apply radiant heat to the membrane to increase the temperature of the membrane to the temperature threshold level.

In yet another aspect, a system is provided. The system includes an identifying unit, a detector inlet having a first end defining a first opening and an opposing second end defining a second opening, the second end coupled in flow communication with the identifying unit, a membrane substantially covering the first opening of the detector inlet, a heating device coupled to the membrane, a radiant heat source, and at least one processor. The at least one processor is programmed to send a signal to impinge a gas carrying a sample of interest to an exterior surface of the membrane, enable the heating device coupled to the membrane to increase a temperature of the membrane to a temperature threshold level, wherein at the temperature threshold level, a permeability of the membrane enables molecules in the sample of interest captured on the exterior surface of the membrane to pass through the membrane, and enable the radiant heat source to apply radiant heat to the membrane to assist the heating device in increasing the temperature of the membrane to the temperature threshold level.

### BRIEF DESCRIPTION OF THE DRAWINGS

FIGS. 1-4 are schematic views of an ion mobility spectrometry detector.

FIG. 5 is a schematic block diagram of a controller for the ion mobility spectrometry detector shown in FIGS. 1-4.

FIG. 6 is a diagram illustrating a process for reducing membrane desorption time in the ion mobility spectrometry detector shown in FIGS. 1-4.

### DETAILED DESCRIPTION OF THE INVENTION

Embodiments of the present disclosure reduce membrane desorption time in an ion mobility spectrometry detector (IMSD). However, while embodiments of the present disclosure are illustrated and described herein with reference to an IMSD, and in particular to IMSD 102, aspects of the present disclosure are operable with any device that performs the functionality illustrated and described herein, or its equivalent.

An exemplary technical effect of the methods and systems described herein includes at least one of (a) impinging a gas carrying a sample of interest on an exterior surface of a membrane; (b) enabling a heating device coupled to the membrane to increase a temperature of the membrane to a temperature threshold level, wherein at the temperature threshold level, a permeability of the membrane enables molecules in the sample of interest captured on the exterior surface of the membrane to pass through the membrane; and (c) enabling a radiant heat source to apply radiant heat to the membrane to assist the heating device in increasing the temperature of the membrane to the temperature threshold level.

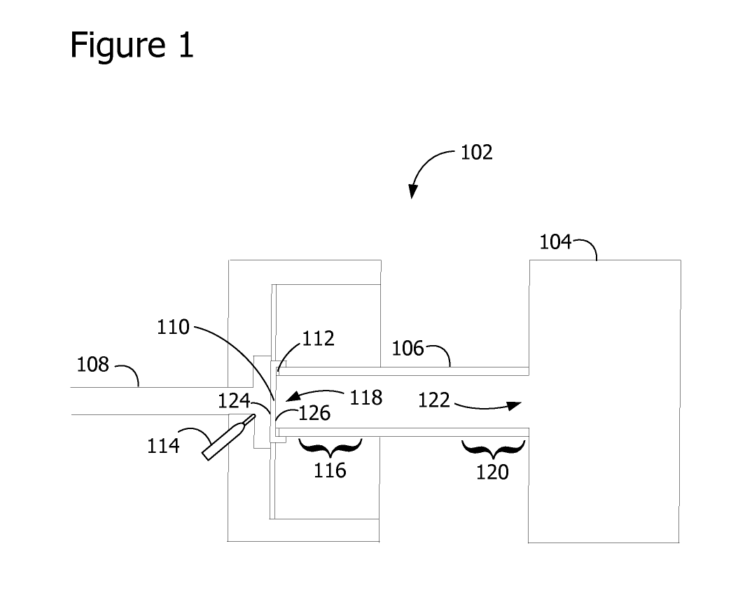

With reference now to FIG. 1, a schematic view of an exemplary IMSD 102 is provided. IMSD 102 includes an identifying unit 104, a detector inlet 106, a gas inlet 108, a membrane 110, a heating device 112, and a radiant heat source 114. One of ordinary skill in the art guided by the teachings herein will appreciate that the schematic of IMSD 102 shown in FIG. 1 is merely illustrative of an exemplary IMSD that can be used in connection with one or more embodiments of the disclosure, and is not intended to be limiting in any way. Further, with respect to identifying unit 104, as used herein, identifying unit 104 represents one or more components/devices used in identifying molecules that have passed through membrane 110. For example, identifying unit 104 may include a chamber for bombarding molecules with electrons to create positive and negative species as well as a detector for measuring a time of flight of each ionized species. Thus, it is contemplated that IMSD 102, and more specifically, identifying unit 104, may include a variety of different components/devices that perform the functionality of identifying molecules that have passed through membrane 110.

Detector inlet 106 includes a first end 116 defining a first opening 118 and an opposing second end 120 defining a second opening 122 coupled in flow communication with identification unit 104. Gas inlet 108 is configured to provide gas carrying a sample of interest, for example, molecules of a compound to be identified, to membrane 110. However, if it is desired to determine whether the atmosphere contains a certain component (e.g., a contaminant), the sample of interest can simply be a sample of ambient air. Membrane 110, which covers first opening 118 of detector inlet 106, is configured to capture the sample of interest on an exterior surface (e.g., surface 124) of membrane 110. In one embodiment, membrane 110 substantially covers (e.g., covers 50% to 75% or more) first opening 118. The quantity of membrane 110 that covers first opening 118 depends on a size, shape, and type of material from which membrane 110 is made. In addition to providing a sampling interface separating the gas carrying the sample of interest from detector inlet 108, membrane 110 also protects detector inlet 108 from being exposed to unwanted particles.

In one embodiment, because a permeability coefficient is a function of a temperature of a membrane, membrane 110 is heated by heating device 112 (e.g., a brass inlet or a copper inlet mounted on an interior surface of membrane 110) prior to membrane 110 being exposed to the gas carrying the sample of interest to increase a permeability of membrane 110. As such, when membrane 110 is heated to a temperature (e.g., a temperature threshold level) that enables desorption, molecules are able to pass through membrane 110. However, one of ordinary skill in the art guided by the teachings herein will appreciate that a permeability of membrane 110 is a continuous function of temperature and thus permeability increases when a temperature of membrane 110 increases. Thus, as used herein, a temperature threshold level may be a minimum temperature that enables desorption, an optimum temperature (e.g., a temperature above the minimum temperature) that optimizes a speed of desorption, or a temperature between the minimum and optimum temperatures.

To prohibit molecules from passing through membrane 110 as soon as the molecules contact membrane 110, the gas carrying the sample of interest is cooled. Thus, the area of membrane 110 exposed to the gas (e.g., the sampling area/a center of membrane 110) is also cooled. As such, a permeability of membrane 110 in the cooled area decreases, prohibiting the molecules of the sample of interest from passing through membrane 110 and allowing the molecules of the sample of interest to be captured on a surface of membrane 110.

In one embodiment, membrane 110 is made of silicone, which is a poor heat conductor. For example, for silicon, thermal diffusivity is 0.16 mm̂2/sec, as opposed to a good heat conductor such as copper, which has a thermal diffusivity of 100 mm̂2/sec. Therefore, in one second, heat diffuses through 0.4 mm of silicone and 10 mm of copper. To put this in perspective, in one embodiment, a sampling area of membrane 110 (e.g., the area of membrane 110 being exposed to the cooled gas and therefore the portion of membrane 110 capturing molecules of the sample of interest) has a radius of about 1 mm. Thus, when the cooled gas carrying the sample of interested is no longer supplied to membrane 110, it will take a few seconds for heat supplied from heating device 112 to diffuse from an outer edge of membrane 110 (the outer edge not being exposed to the cooled gas), to the sampling area (e.g., a center of membrane 110). Thus, being that the entire process from providing a gas carrying a sample of interest to identifying molecules in the sample of interest takes approximately eight seconds, waiting three, two, or even just one second for heat to diffuse across membrane 110 is critical time being wasted.

To decrease a time it takes to heat membrane 110, and more specifically, the sampling area of membrane 110 after the sampling area is exposed to a cooled gas, radiant heat source 114 is used to apply radiant heat to the sampling area of membrane 110. As such, with radiant heat source 114 assisting heating device 112, a time it takes to increase the temperature of the sampling area to the temperature threshold level, is reduced to less than one second, for example, to as little as one micro second. In one embodiment, radiant heat source 114 is an infrared laser. In another embodiment, radiant heat source is a jet of hot air.

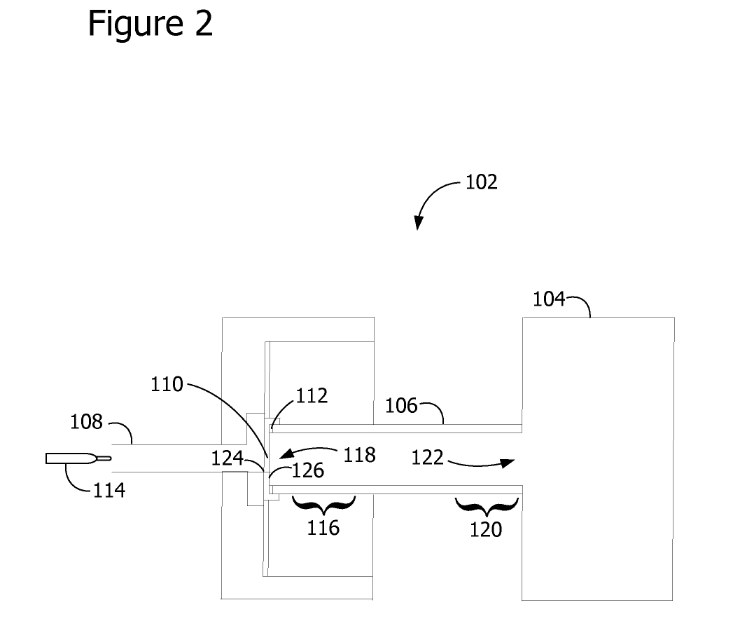

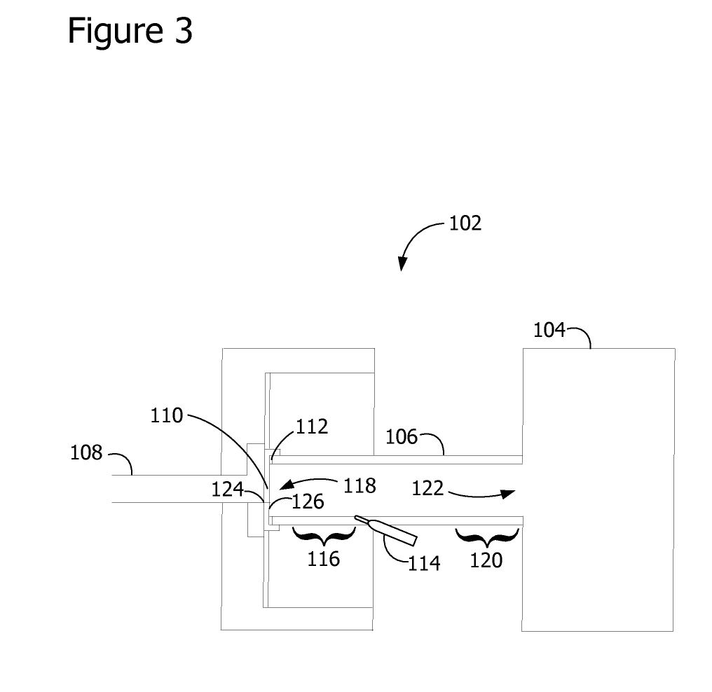

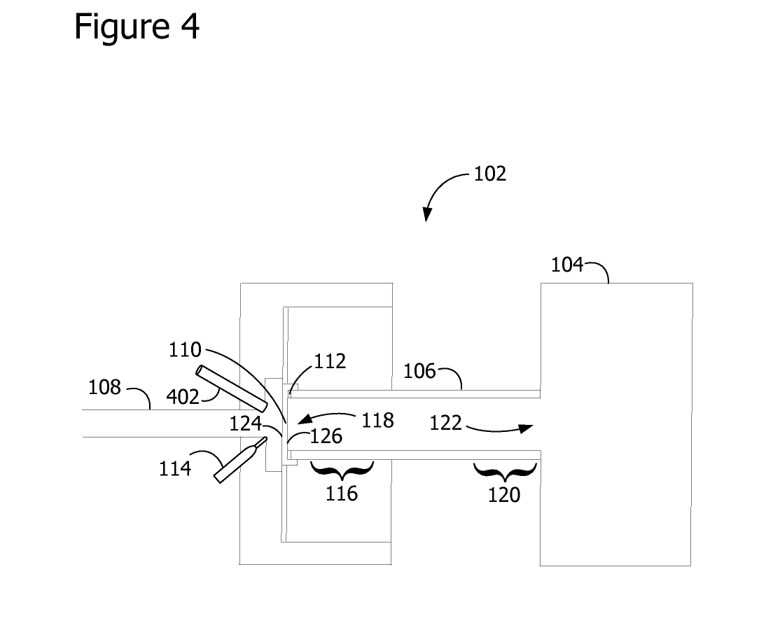

As shown in FIG. 1, radiant heat source 114 is configured to apply radiant heat to exterior surface 124 of membrane 110. However, while the location of radiant heat source 114 is shown in FIG. 1 to be just “below” gas inlet 108 at a distance D from membrane 110, one of ordinary skill in the art guided by the teachings herein will appreciate that radiant heat source 114 may be located at different locations and different distances from membrane 110. For example, FIG. 2 is schematic view of ion mobility detector 102 with radiant heat source 114 configured to provide radiant heat through gas inlet 108 to exterior surface 124 of membrane 110. Further, FIG. 3 is schematic view of IMSD 102 with radiant heat source 114 configured to provide radiant heat to an interior surface 126 of membrane 110. In addition, one of ordinary skill in the art guided by the teachings herein will appreciate that embodiments of the present disclosure may include an additional heat source (e.g., additional heat source 402 shown in FIG. 4) to apply heat to membrane 110 to assist heating device 112 and radiant heat source 114 with increasing a temperature of membrane 110 to the temperature threshold level. In one embodiment, additional heat source 402 is a radiant heat source. In another embodiment, radiant heat source 402 is a resistive heat source. In addition, a heating source may be applied to both, interior surface 126 and exterior surface 124.

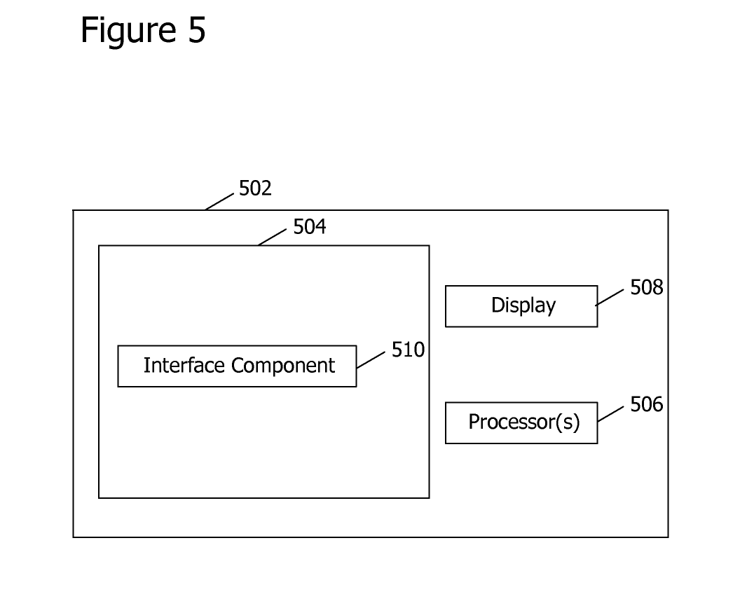

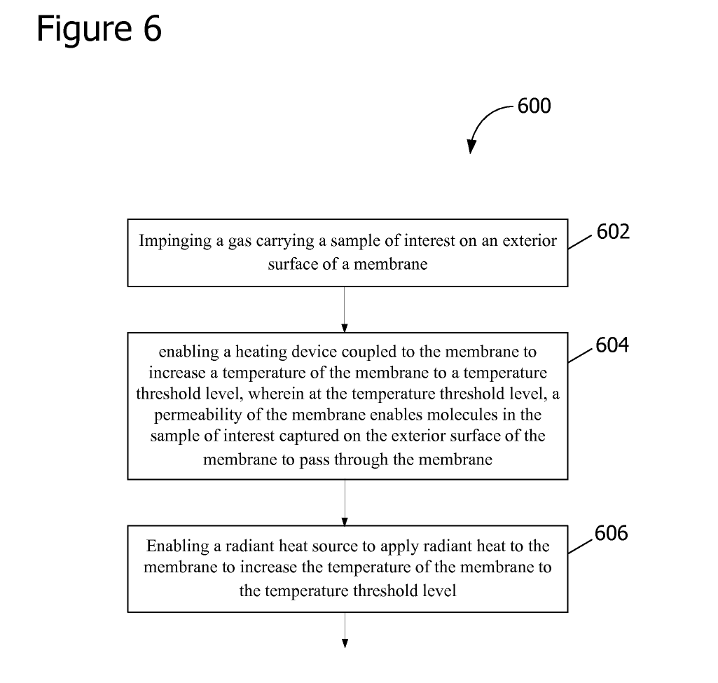

Referring next to FIG. 5, a schematic block diagram of a controller 502 operatively coupled to IMSD 102 is provided. Controller 502 has a memory area 504, at least one processor 506, and a display 508. In general, at least one processor 506 may be programmed with instructions such as described hereinafter with reference to the components illustrated in FIGS. 1-4 and the operations illustrated in FIG. 6.

Display 508 may be, for example, a display device separate from controller 502, a display integrated into controller 502, a capacitive touch screen display, or a non-capacitive display. User input functionality may also be provided in display 508, which may act as a user input selection device such as a touch screen.

Memory area 504 stores instructions, calibration constants, elements of selected detection process (e.g., data necessary for a molecule to be detected/identified), and other information to satisfactorily complete a selected detection/identification process, as well as one or more computer-executable components. Further, memory area 504 includes interface component 510 that, when executed by processor 506, causes processor 506 to receive user defined settings for a detection/identification process.

Referring next to FIG. 6, an exemplary flow chart illustrates a process 600 for reducing membrane desorption time in IMSD 102 (as shown in FIG. 1). The process includes impinging, at 602, a gas carrying a sample of interest on exterior surface 124 (as shown in FIGS. 1-4) of membrane 110 (as shown in FIGS. 1-5). At 604, heating device 112 (as shown in FIGS. 1-5) is enabled to increase a temperature of membrane 110 to a temperature threshold level such that molecules in a sample of interest captured on exterior surface 124 of membrane 110 are able to pass through membrane 110. At 606, radiant heat source 116 (as shown in FIGS. 1-5) is enabled to apply radiant heat to membrane 110 to assist heating device 112 with increasing a temperature of membrane 110 to the temperature threshold level. In one embodiment, the gas carrying the sample of interest is impinged on membrane 110 for a defined period of time, for example, about six nanoseconds. Thus, radiant heat source 116 applies radiant heat to membrane 110 after the defined period of time, for example, after the sampling is complete.

### Exemplary Operating Environment

A controller such as described herein may have one or more processors or processing units, system memory, and some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal, such as a carrier wave or other transport mechanism, and include any information delivery media. Combinations of any of the above are also included within the scope of computer readable media.

The controller may operate in a networked environment using logical connections to one or more remote computers. Although described in connection with an exemplary computing system environment, embodiments of the present disclosure are operational with numerous other general purpose or special purpose computing system environments or configurations. The computing system environment is not intended to suggest any limitation as to the scope of use or functionality of any aspect of the present disclosure. Moreover, the computing system environment should not be interpreted as having any dependency or requirement relating to any one or combination of components illustrated in the exemplary operating environment. Examples of well known computing systems, environments, and/or configurations that may be suitable for use with aspects of the present disclosure include, but are not limited to, personal computers, server computers, hand-held or laptop devices, multiprocessor systems, microprocessor-based systems, minicomputers, mainframe computers, distributed computing environments that include any of the above systems or devices, and the like.

Embodiments of the present disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the present disclosure may be implemented with any number and organization of such components or modules. For example, aspects of the present disclosure are not limited to the specific computer-executable instructions or the specific components or modules illustrated in the figures and described herein. Other embodiments of the present disclosure may include different computer-executable instructions or components having more or less functionality than illustrated and described herein. Aspects of the present disclosure may also be practiced in distributed computing environments where tasks are performed by remote processing devices that are linked through a communications network. In a distributed computing environment, program modules may be located in both local and remote computer storage media including memory storage devices.

Aspects of the present disclosure transform a general-purpose computer into a special-purpose computing device when configured to execute the instructions described herein.

The order of execution or performance of the operations of embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

When introducing elements of aspects of the present disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

This written description uses examples to disclose the claimed subject matter, including the best mode, and also to enable any person skilled in the art to practice the claimed subject matter, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An ion mobility spectrometer comprising:
an identifying unit;
a detector inlet having a first end defining a first opening and an opposing second end defining a second opening, the second end coupled in flow communication with the identifying unit;
a gas inlet configured to provide gas carrying a sample of interest;
a membrane substantially covering the first opening of the detector inlet, the membrane in communication with the gas carrying the sample of interest, the membrane configured to capture the sample of interest on an exterior surface of the membrane;
a heating device coupled to the membrane, the heating device configured to increase a temperature of the membrane to a temperature threshold level by heat diffusion once the sample of interest is captured, wherein at the temperature threshold level, a permeability of the membrane enables molecules in the captured sample of interest to pass through the membrane and into the detector inlet; and
a radiant heat source configured to apply radiant heat to the membrane to increase the temperature of the membrane to the temperature threshold level.

2. The ion mobility spectrometer in accordance with claim 1, wherein the heating device is one of a brass or copper inlet.

3. The ion mobility spectrometer in accordance with claim 2, wherein the membrane is mounted on the one of the brass or copper inlet.

4. The ion mobility spectrometer in accordance with claim 1, wherein the radiant heat source is one or more of the following: an infrared laser or a jet of hot air.

5. The ion mobility spectrometer in accordance with claim 1, wherein the radiant heat source applies radiant heat to a portion of the membrane that includes the molecules of the captured sample of interest.

6. The ion mobility spectrometer in accordance with claim 1, wherein the radiant heat source applies radiant heat to the exterior surface of the membrane.

7. The ion mobility spectrometer in accordance with claim 1, wherein the radiant heat source applies radiant heat to an interior surface of the membrane and/or an exterior surface of the membrane.

8. A method comprising:
impinging a gas carrying a sample of interest on an exterior surface of a membrane;
enabling a heating device coupled to the membrane to increase a temperature of the membrane to a temperature threshold level, wherein at the temperature threshold level, a permeability of the membrane enables molecules in the sample of interest captured on the exterior surface of the membrane to pass through the membrane; and
enabling a radiant heat source to apply radiant heat to the membrane to increase the temperature of the membrane to the temperature threshold level.

9. The method in accordance with claim 8, wherein the gas carrying the sample of interest is impinged on the membrane for a defined period of time.

10. The method in accordance with claim 9, wherein the radiant heat source applies radiant heat to the membrane after the defined period of time.

11. The method in accordance with claim 8, wherein the radiant heat is applied to the exterior surface of the membrane.

12. The method in accordance with claim 8, wherein the radiant heat is applied to an interior surface of the membrane.

13. The method in accordance with claim 8, wherein the radiant heat is applied to a portion of the membrane that includes the molecules of the captured sample of interest.

14. The method in accordance with claim 8, further comprising enabling an additional heat source to increase the temperature of the membrane to the temperature threshold level.

15. A system comprising:
an identifying unit;
a detector inlet having a first end defining a first opening and an opposing second end defining a second opening, the second end coupled in flow communication with the identifying unit;
a membrane substantially covering the first opening of the detector inlet;
a heating device coupled to the membrane;
a radiant heat source; and
at least one processor programmed to:
send a signal to impinge a gas carrying a sample of interest to an exterior surface of the membrane;
enable the heating device coupled to the membrane to increase a temperature of the membrane to a temperature threshold level, wherein at the temperature threshold level, a permeability of the membrane enables molecules in the sample of interest captured on the exterior surface of the membrane to pass through the membrane; and
enable the radiant heat source to apply radiant heat to the membrane to assist the heating device in increasing the temperature of the membrane to the temperature threshold level.

16. The system in accordance with claim 15, wherein the radiant heat source is an infrared laser.

17. The system in accordance with claim 15, wherein the gas carrying the sample of interest is impinged on the membrane for a defined period of time.

18. The system in accordance with claim 17, wherein the radiant heat source is enabled to apply radiant heat to the membrane after the defined period of time.

19. The system in accordance with claim 15, wherein the radiant heat is applied to a portion of the membrane that includes the molecules of the captured sample of interest.

20. The system in accordance with claim 15, further comprising an additional heat source, and wherein the at least one processor is programmed to enable the additional heat source to apply heat to the membrane to assist the heating device and the radiant heat source in increasing the temperature of the membrane to the temperature threshold level.
